(19) United States
(12) Patent Application Publication
(10) Pub. No.: US 2017/0010874 A1
(43) Pub. Date: Jan. 12, 2017

(54) PROVISIONING STORAGE DEVICES IN A DATA CENTER

(71) Applicant: CISCO TECHNOLOGY, INC., San Jose, CA (US)

(72) Inventors: Sebastien Thierry Rosset, Sunnyvale, CA (US); Lakshman Ganesh Rajamani, San Jose, CA (US); Song Lu, Saratoga, CA (US)

(73) Assignee: CISCO TECHNOLOGY, INC., San Jose, CA (US)

(21) Appl. No.: 14/792,385

(22) Filed: Jul. 6, 2015

(51) Int. Cl. G06F 9/445

(52) U.S. Cl. CPC G06F 8/61; G06F 8/65

(57) ABSTRACT

In one embodiment, a fabric interconnect device accesses a software inventory of a storage device comprising a plurality of hardware components including at least one storage controller and a plurality of storage mediums. At least one entry of the software inventory identifies a hardware component of the storage device and an indication of at least one version of software installed for use by the hardware component or an indication that no software is installed for use by the hardware component. The fabric interconnect device determines whether one or more versions of software are available for use by the hardware component. The fabric interconnect device initiates installation of at least one version of software for the hardware component of the storage device based on the determination.

### TECHNICAL FIELD

This disclosure relates in general to the field of data storage and, more particularly, to provisioning storage devices in a data center.

### BACKGROUND

A data center may include various components such as one or more chassis that may each house any number of compute blades and storage blades, one or more racks that may each house one or more rack servers, and one or more fabric interconnect devices that allow communication between the components of the data center. Over the lifetime of the data center, various storage devices may be added to the data center. For example, a chassis or rack may include various slots into which a storage device with one or more storage arrays may be inserted. Various provisioning operations may be performed when a storage device is installed or at other times.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates an example block diagram of a system for provisioning storage devices in a data center in accordance with certain embodiments.

FIG. 2 illustrates an example block diagram of a fabric interconnect device in accordance with certain embodiments.

FIG. 3 illustrates an example block diagram of a storage device in accordance with certain embodiments.

FIG. 4 illustrates an example block diagram of a compute device in accordance with certain embodiments.

FIG. 5 illustrates an example method for detecting and upgrading a storage device in accordance with certain embodiments.

FIG. 6 illustrates an example method for upgrading a storage device based on user input in connection with system impact information in accordance with certain embodiments.

FIG. 7 illustrates an example method for maintaining availability of a storage device during upgrading of the storage device in accordance with certain embodiments.

FIG. 8 illustrates an example method for maintaining availability of a storage medium group during storage medium upgrading in accordance with certain embodiments.

### DETAILED DESCRIPTION OF EXAMPLE EMBODIMENTS

### Overview

In one embodiment, a fabric interconnect device accesses a software inventory of a storage device comprising a plurality of hardware components including at least one storage controller and a plurality of storage mediums. At least one entry of the software inventory identifies a hardware component of the storage device and an indication of at least one version of software installed for use by the hardware component or an indication that no software is installed for use by the hardware component. The fabric interconnect device determines whether one or more versions of software are available for use by the hardware component. The fabric interconnect device initiates installation of at least one version of software for the hardware component of the storage device based on the determination.

### Example Embodiments

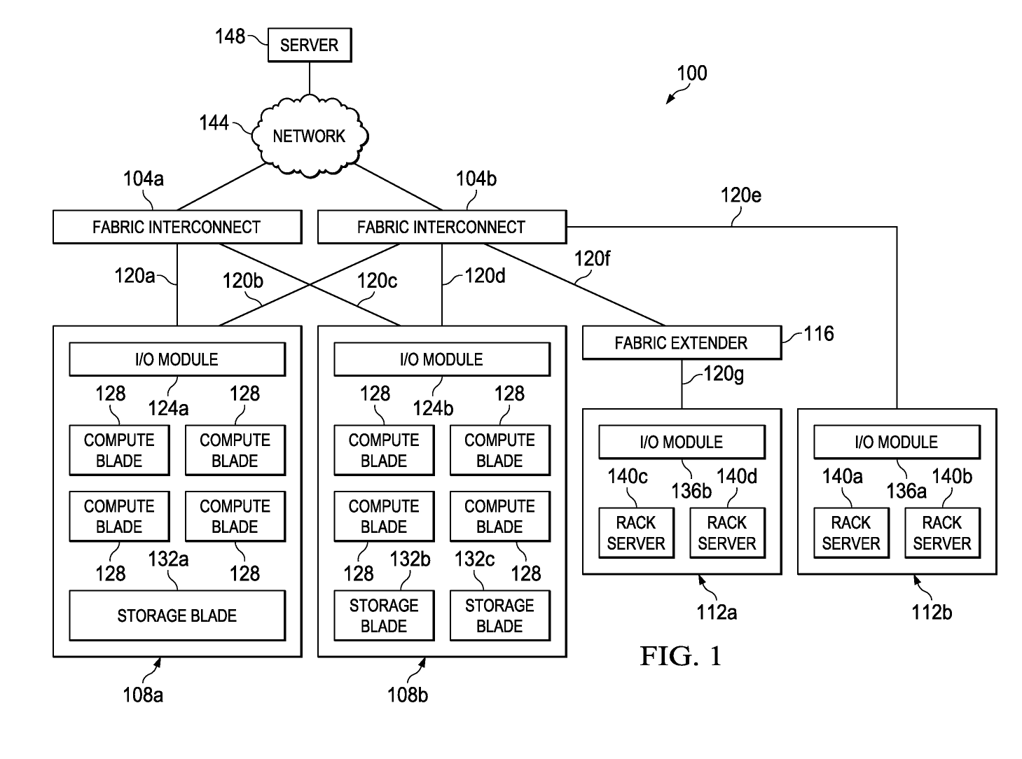

FIG. 1 illustrates an example block diagram of a system 100 for provisioning storage devices in a data center in accordance with certain embodiments. System 100 includes two fabric interconnect devices 104a and 104b coupled to two chassis 108a and 108b and two racks 112a and 112b. Fabric interconnect device 104b is coupled to rack 112a through fabric extender 116. The fabric interconnect devices 104 are further coupled to a server 148 through network 144.

Each chassis 108 includes one or more I/O modules 124, one or more compute blades 128, and one or more storage blades 132. Each rack includes one or more I/O modules 136 and one or more rack servers 140. The compute blades 128 and/or rack servers 140 may comprise computing systems such as servers capable of serving requests from a client or performing other processing tasks. The storage blades 132 and some or all of the rack servers may each include a storage array comprising a plurality of storage mediums for storing data. Server 148 may include a software repository for software that may be installed on the compute blades 128, storage blades 132, or rack servers 140.

Various embodiments of the present disclosure provide a system 100 for automatically provisioning storage devices (e.g., storage blades 132 or rack servers 140) upon installation of the devices and for performing software upgrades for the storage devices when upgrades are available. When a user physically inserts a storage blade 132, connects a rack server 140, or couples a different storage device to a fabric interconnect device 104, a management system of the fabric interconnect device 104 may set up a communication path to communicate with the storage device. The management system may also discover the hardware and software components (including firmware) of the installed storage device. System 100 may determine whether upgradable software components (i.e., software components that may be used to upgrade the functionality of the storage device) are available for the storage device and may initiate an upgrade of the software components of the installed storage device. In other embodiments, upgradable software components may be identified and installed at any suitable time, such as during a time when the storage device is operating (i.e., serving storage requests received from other devices of system 100).

In various embodiments, the software upgrade does not cause any disruption to the initiators (e.g., compute blades 128 or rack servers 140) that are accessing the storage device. In certain embodiments, the management system analyzes the availability of all the paths between the storage initiators and the storage device that will be upgraded. If one or more of the initiators do not have enough paths available to the storage device such that a non-disruptive upgrade (with respect to the initiators) of the storage device may be performed by the fabric interconnect device 104, a user may be notified and presented with an option of whether to proceed with the upgrade.

The storage array discovery process is simplified compared to other processes which may be used by storage array orchestration tools which require a management IP address to be configured manually on the storage device. Moreover, with some systems, upgrades are performed manually and require multiple tools to perform the upgrade of all software components. As an example, in some systems, a user may install a storage device (e.g., insert a storage blade), log in to a system manager (e.g., through a keyboard) of the storage device, perform preconfiguration (e.g., set up IP addresses, host name, gateways, etc.), manually install software on the storage device through an ISO image, and then access a management subsystem on the storage device to upgrade the software components of the storage device.

In various embodiments of the present disclosure, the management system does not require any explicit user configuration of a management interface on the storage device or other user input or actions before or during the software upgrade process.

In the embodiment depicted, two fabric interconnect devices 104 are shown. Other embodiments may include additional or fewer fabric interconnect devices 104. In a particular embodiment, a fabric interconnect device 104 may comprise a switching and/or routing device with a plurality of ports that may be coupled to one or more devices of the data center through any suitable communication link (e.g., through an air, electrical, optical, or other communication medium). For example, device 104 may comprise an Ethernet, a Fibre Channel, Fibre Channel over Ethernet, and/or other type of switching device and/or routing device.

In the embodiment depicted, device 104a is coupled to chassis 108a through link 120a and to chassis 108b through link 120c while device 104b is coupled to chassis 108a through link 120b, to chassis 108b through link 120d, to rack 112b through link 120e, and to rack 112a through link 120f, fabric extender 116, and link 120g. In the embodiment depicted, the fabric interconnect devices 104 are coupled to the chassis and racks (e.g., through I/O modules 124 and 136), though in other embodiments the devices 104 may be coupled directly to individual storage devices within the chassis and racks. Any suitable number of links 120 may couple a fabric interconnect device 104 to a rack, chassis, or device within a rack or chassis. For example, multiple links between devices may facilitate high availability.

Fabric extender 116 is a switching device that may be coupled to one or more ports of a fabric interconnect device 104b and to a plurality of devices. The purpose of the fabric extender is to provide additional physical ports, to increase the number of additional devices may be coupled to a fabric interconnect device 104. Thus a fabric extender 116 may have more ports that couple to devices (e.g., chassis, racks, compute blades, storage blades, rack servers, etc.) than ports that couple to fabric interconnect device 104 and may switch data between the fabric interconnect device 104 and the other devices coupled to the fabric extender 116.

Chassis 108 may include slots configured to electrically and mechanically couple to various devices, such as one or more compute blades 128 or storage blades 132, one or more I/O modules 124, one or more power supplies for powering the components of chassis 108, one or more fan trays for cooling the various components of chassis 108, or other devices. As an example, a circuit board containing the components of a device may be placed in a slot of the chassis 108.

A rack 112 may function in a similar manner to that of a chassis and may include devices that perform functionalities similar to those of the devices of a chassis 108. Rack 112 may include multiple mounting slots (i.e., bays) that are designed to hold a hardware component in place with a securing mechanism (e.g., screws). A rack may include multiple devices (e.g., rack servers 140, I/O modules 136, etc.) stacked together. The rack may minimize required floor space and facilitate coupling among the components of the rack. Rack 112 may also include a cooling system to dissipate heat generated by the devices installed in the rack.

I/O module 124 is capable of coupling the various devices (e.g., compute blades 128 or storage blades 132) in the chassis together (e.g., through their respective ports) and of coupling the various devices in the chassis to other devices through, for example, one or more fabric interconnect devices 104, fabric extenders 116, and/or other communication devices. In a particular embodiment, I/O module 124 may direct communications to the devices in the chassis based on addresses included in the communications. For example, each device may be addressable by an address that is unique within system 100, such as an IP address or other address. I/O module 136 may provide functionality within a rack 112 for rack servers 140 in a manner similar to that provided by I/O module 124 for the chassis.

The compute blades 128 and/or rack servers 140 may function as compute devices that comprise computing systems. A compute device may perform any suitable operations, such as serving requests received over a network from a client, initiating storage requests for (e.g., writes to or reads from) storage devices of the data center (e.g., storage blades 132 or rack servers 140), or other suitable processing operations. In various embodiments, a compute device may create logical unit numbers (LUNs) on a storage device and then write data to and read data from those LUNs.

The storage blades 132 and/or rack servers 140 may function as storage devices. A storage device may include a storage array that each comprise a plurality of storage mediums for storing data. A storage device may include any suitable storage mediums, such as disks, tapes, solid state drives, or other suitable mediums. Data may be recorded on a storage medium by any suitable means, such as electronic, magnetic, optical, or mechanical changes to a surface or other layer of the storage medium. A storage device, may include any suitable number of storage mediums. For example, in one embodiment a storage blade 132 may include sixteen discrete storage disks.

Particular rack servers 140 may be configured to function as compute devices while other rack servers 140 may be configured to function as storage devices. By locating mass storage capability on particular devices (i.e., storage blades 132 and the rack servers 140 functioning as storage devices), the compute devices may be cheaper because they do not need to include mass storage capability and may be swapped out more easily since they do not have to store user data.

Server 148 may include one or more computer systems configured to store software that may be used by devices of system 100. Server 148 may store any type of software, such as operating systems (OSs), device drivers, BIOS, storage medium firmware, or other software used by storage devices of system 100. In various embodiments, when an updated version of software is developed, it may be uploaded to server 148. As an alternative, server 148 may be configured to periodically check various sources for updated software or software for new components and download the software when it becomes available. Server 148 is operable to receive a request from a fabric interconnect device 104 for one or more software modules, retrieve the software modules, and send the modules to the requesting fabric interconnect device 104. In some embodiments, a user may transfer any of the software described herein directly to a fabric interconnect device via a storage medium coupled to the device (e.g., through a USB connection).

A network 144 represents a series of one or more communication links, points, nodes, or network elements of interconnected communication paths for receiving and transmitting packets of information that propagate through a communication system. A network offers a communicative interface between sources and/or hosts, and may be any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology. A network can comprise any number of hardware or software elements coupled to (and in communication with) each other through a communications medium. In some embodiments, a network may simply comprise a cable (e.g., an Ethernet cable), air, or other transmission medium. Communication within network 144 may be in accordance with the transmission control protocol/internet protocol (TCP/IP) and/or any other suitable protocol for the transmission and/or reception of packets in a network.

Any of the components described herein (e.g., a fabric interconnect device, storage device, compute device, or server) may include one or more portions of one or more computer systems. In particular embodiments, one or more of these computer systems may perform one or more steps of one or more methods described or illustrated herein. In particular embodiments, one or more computer systems may provide functionality described or illustrated herein. In some embodiments, encoded software running on one or more computer systems may perform one or more steps of one or more methods described or illustrated herein and/or provide functionality described or illustrated herein. The components of the one or more computer systems may comprise any suitable physical form, configuration, number, type, and/or layout. Where appropriate, one or more computer systems may be unitary or distributed, span multiple locations, span multiple machines, or reside in a cloud, which may include one or more cloud components in one or more networks.

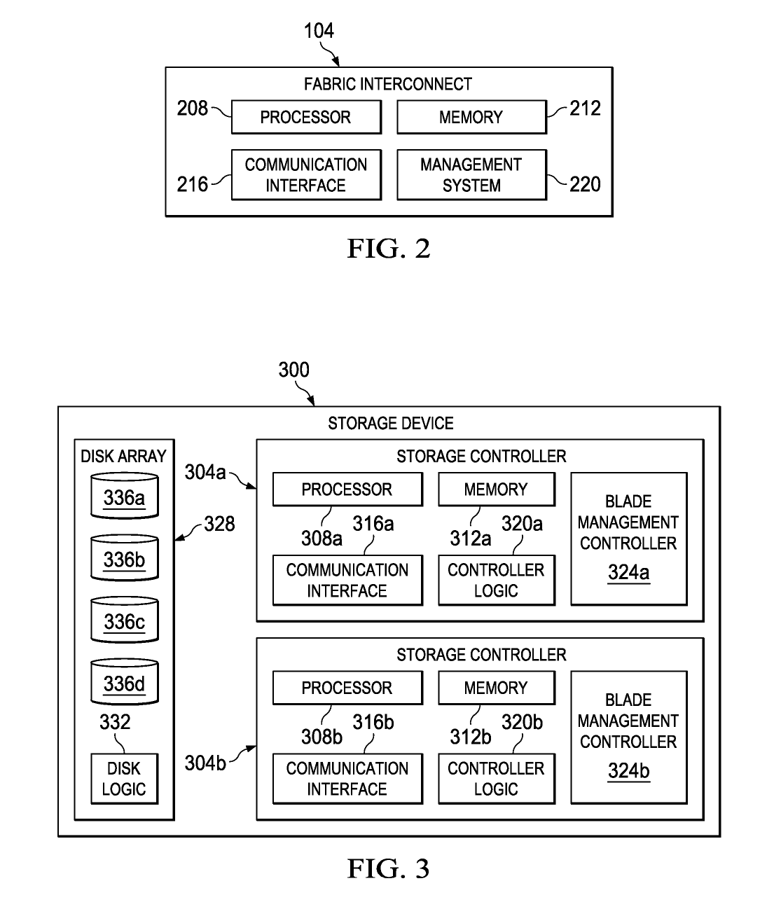

In the embodiments depicted in FIGS. 2-4, fabric interconnect device 104, storage device 300, and compute device 400 each include a computer system to facilitate performance of its operations. In particular embodiments, a computer system may include a processor, memory (providing long term and/or short term storage of data), one or more communication interfaces, and various other logic. As an example, fabric interconnect device 104 comprises a computer system that includes one or more processors 208, memory 212, and one or more communication interfaces 216; storage device 300 comprises a computer system that includes one or more processors 308, memory 312, and one or more communication interfaces 316; and compute device 400 includes one or more processors 408, memory 412, and one or more communication interfaces 416. These components may work together in order to provide functionality described herein.

Communication interfaces 216, 316, and 416 may be used for the communication of signaling and/or data between devices of system 100 and one or more networks (e.g., 144) and/or other devices. For example, communication interfaces 216, 316, and 416 may be used to send and receive network traffic such as data packets. Each communication interface may send and receive data and/or signals according to a distinct standard such as Asynchronous Transfer Mode (ATM), Frame Relay, Gigabit Ethernet (or other IEEE 802.3 standard), or other communication standard. As one example, communication interface interfaces 216, 316, and 416 may each include one or more network adapters with one or more Ethernet or Fibre Channel ports.

A processor 208, 308, and 408 may be a microprocessor, controller, or any other suitable computing device, resource, or combination of hardware, stored software and/or encoded logic operable to provide, either alone or in conjunction with other components of its respective device, the functionality of the device. In some embodiments, a device may utilize multiple processors to perform the functions described herein.

The processor can execute any type of instructions to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions may be executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

Memory 212, 312, and 412 may comprise any form of volatile or non-volatile memory including, without limitation, magnetic media (e.g., one or more disk drives or tape drives), optical media, solid state media, random access memory (RAM), read-only memory (ROM), removable media, or any other suitable local or remote memory component or components. Memory 212, 312, and 412 may store any suitable data or information utilized by its respective device, including software embedded in a computer readable medium, and/or encoded logic incorporated in hardware or otherwise stored (e.g., firmware). Memory 212, 312, and 412 may also store the results and/or intermediate results of the various calculations and determinations performed by its respective device.

In certain example implementations, the functions outlined herein may be facilitated by logic encoded in one or more non-transitory, tangible media (e.g., embedded logic provided in an application specific integrated circuit (ASIC), digital signal processor (DSP) instructions, software (potentially inclusive of object code and source code) to be executed by one or more processors, or other similar machine, etc.). In some of these instances, one or more memory elements can store data used for the operations described herein. This includes the memory element being able to store instructions (e.g., software, code, etc.) that are executed to carry out the activities described in this Specification.

Any of the memory items discussed herein may be construed as being encompassed within the broad term ‘memory element.’ Similarly, any of the potential processing elements, modules, and machines described in this Specification may be construed as being encompassed within the broad term ‘processor.’

In addition to the computer systems described above, FIGS. 2-4 depict additional elements that facilitate the operations of the devices depicted therein. These additional elements will now be described in more detail.

FIG. 2 illustrates an example block diagram of a fabric interconnect device 104 in accordance with certain embodiments. In addition to the computer system elements described above, fabric interconnect device 104 includes a management system 220. The management system may be distinct from, integrated with, include, and/or utilize any of the other components of fabric interconnect device 104.

Management system 220 may perform various functions, such as automatic discovery of various devices (e.g., compute blades 128, storage blades 132, and rack servers 140) and their components within system 100, configuring the devices and components, maintaining an inventory of hardware and installed software for the devices and components, checking for software to upgrade for the devices and components, transferring software to the devices and components for installation, and monitoring the health of the devices and their components. In various embodiments, management system 220 stores the information it collects about the devices and their components in a database.

When management system 220 is run on the fabric interconnect device 104 for the first time, a user may initiate the discovery process by configuring one or more server ports on the fabric interconnect device 104. Fabric interconnect device 104 may include several types of ports, such as at least one server port which handles traffic between the fabric interconnect device 104 and the other devices (e.g., compute blades, storage blades, rack servers) of system 100. In various embodiments, the server ports of the fabric interconnect device 104 may be connected to the devices in the various chassis 108 and racks 112 through I/O Modules 124 and 136.

When the server ports are configured on a fabric interconnect device 104, the ports understand that they are to receive control packets from end points such as I/O Modules 124 and 136, blades 128 and 132, rack servers 140, and/or other end points. In one embodiment, a control protocol (e.g., Satellite Discovery Protocol or other suitable protocol) is run between the fabric interconnect device 104 and the I/O Modules 124 and 136. The I/O Modules 124 and 136 may periodically send control packets to the fabric interconnect device 104 and once the server port is enabled, the management system 220 running on the fabric interconnect device 104 detects the presence of the I/O modules 124 and 136 and will then proceed to discover all the components associated with the I/O modules 124, starting with the chassis 108 and racks 112. Subsequently, the control protocol may establish layer 2 and layer 3 links between the fabric interconnect device 104 and the I/O modules 124 and 136 through which the fabric interconnect device 104 can reach the chassis and all the blades in the chassis and the rack and its rack servers 140. Once the links are established, the management system 220 can proceed with the discovery of the compute blades 128, storage blades 132, rack servers 140 and their respective components. The discovery and provisioning process that takes place with respect to a storage device is discussed in further detail below in connection with FIG. 3. When a new storage blade 132 is inserted into chassis 108, a chassis management controller on the I/O module 124 may detect the new blade and send a message to the management system 220 reporting the presence of the new blade. Similarly, when a new rack server 140 is installed in a rack 112 and coupled to I/O module 136, I/O module 136 may send a message to the management system 220 reporting the presence of the new rack server.

In various embodiments, when a management system 220 detects a device (e.g., storage blade 132, compute blade 128, or rack server 140) within system 100 (e.g., during the first time the management system is run or when the device is installed), management parameters (e.g., a unique address such as an IP address) are automatically pushed from the management system 220 to the device. In various embodiments, IPv6 or IPv4 link-local or loopback addresses are assigned by the management system 220 to the devices. In one embodiment, management system 220 stores a list of available addresses and selects one of the available addresses from this list for a new device. In another embodiment, the management system 220 may push the list of available addresses to the device, and the device may select one of the addresses for itself. In other embodiments, an IP address for a device can be configured through Dynamic Host Configuration Protocol (DHCP) utilizing a DHCP server. When an installer starts on the device or the device boots, the management interface parameters (including the assigned address) may be retrieved locally by the device. The address of the device may then be used by the device to communicate with the management system 220. For example, the device may include the address in messages sent to the management system 220 and the management system 220 may address messages intended for the device to the address.

In various embodiments, management system 220 can also provision logical computers in system 100. A logical computer can be deployed on any physical computer (e.g., compute blade 128 or rack server 140) that supports the logical configuration requirements. Logical configuration requirements may specify one or more hardware or software attributes for the logical computer (e.g., required software bundles, processing power, memory, Ethernet interfaces, etc.).

In systems including a plurality of fabric interconnect devices 104, a management system 220 of one of the fabric interconnect devices 104 may function as the primary management system while a management system of another fabric interconnect device functions as a backup management system. The management systems may communicate with each other to synchronize the information tracked by the primary management system so that the backup management system may seamlessly assume a role as the primary management system if the other management system goes down.

In various embodiments, a user may communicate with management system 220 via one or more interfaces such as an application programming interface (API), graphical user interface (GUI), command-line interface (CLI), or other suitable input means. For example, the interface may allow the user to provide configuration information (e.g., logical computer specifications) for the fabric interconnect device 104 or a device or component coupled to the fabric interconnect device. As another example, the interface may allow the user to receive information from the management system, such as hardware or software inventory information of a device or component, health status of a device or component, or other suitable information. In various embodiments, any of these functions may be performed without requiring the user to enter any device credentials. Thus, instead of having to log in to a particular device, the user may instead log in to management system 220 to configure or receive information from the devices of system 100 and the management system 220 will communicate with the particular device on behalf of the user.

FIG. 3 illustrates an example block diagram of a storage device 300 in accordance with certain embodiments. The components of storage device 300 may represent example components of a storage blade 108, rack server 140, or other storage device. Storage device 300 includes two storage controllers 304 which each include computer system elements as described above, controller logic 320 and blade management controller 324.

In the embodiment depicted, storage device 300 includes two storage controllers, though other embodiments may include fewer or additional storage controllers. When a storage device includes multiple storage controllers 304, one of the storage controllers 304 may function as an active storage controller while one or more of the other storage controllers may function as a passive storage controller. The active storage controller may service storage requests received from the other devices of system 100 (by communicating with disk array 328), while the passive storage controller is idle with respect to storage requests. In some embodiments, the management system 220 of fabric interconnect device may track the states of the storage controllers and forward all storage requests to the active storage controller. In various embodiments, the storage controllers may communicate with each other or with other components (e.g., management system 220) of system 100 to determine which controller should serve as the active storage controller. In particular embodiments, the passive storage controller may take over the role of active storage controller in response to receiving a message instructing it to do so.

A storage controller 304 includes hardware and software enabling the storage controller to communicate with other devices in system 300 and facilitate the performance of storage operations initiated by other devices of system 100 on disk array 328. Each storage controller 304 may run its own operating system (or multiple operating systems) by utilizing memory 312 and processor 308 (e.g., each controller may execute storage stack software as described in further detail below). In various embodiments, a storage management engine running on the operating system may process storage requests received by storage device 300 and provide the results to other devices of system 100. In particular embodiments, management system 220 of fabric interconnect device 104 may establish a connection (e.g., a TCP connection) with the storage management engine of storage device 300 and direct storage requests to the storage management engine through this connection.

The blade management controller 324 of the storage controller is operable to receive requests (e.g., configuration requests related to components within storage device 300) via communication interface 316, initiate the performance of operations specified by the requests, and generate control packets or other information to send to other devices of system 100. Examples of operations that may be performed and/or initiated by blade management controller include powering on or powering off any of the components of storage device 300, accessing hardware or software inventory of the components of storage device 300, accessing sensor data associated with any component of storage device 300 (e.g., voltages, currents, temperature, etc.), and monitoring storage device 300.

Controller logic 320 may include any suitable logic to support the operations of the storage controller 304. As an example, controller logic 320 may include a basic input/output system (BIOS) executed by the processor 308, a Serial Attached SCSI (SAS) expander, an SAS-SATA bridge, a power sequencer, a retimer for communication links to I/O modules, a Non-Volatile Dual In-line Memory Module (NVDIMM) field-programmable gate array (FPGA) that may serve as a buffer for information passed between a device of system 100 and the disk array 328 such that the data may be recovered if there is a power loss, or other suitable logic used by controller 304.

Storage device 300 also includes a disk array 328 having a plurality of storage disks 336 and disk logic 332 (which in other embodiments may be any suitable group of storage media). Disk logic 332 may include any suitable logic for receiving commands from the storage controller and implementing the commands on one or more of the disks 336. For example, disk logic 332 may include a disk controller (e.g., a SCSI controller) operable to receive memory commands from an operating system of storage controller 304 and direct the appropriate disk(s) 336 to perform the commands. The disk controller may also receive results from disk(s) 336 and provide the results to the operating system of the storage controller 304 from which the command was received. In some embodiments, the disk controller implements redundant array of independent disks (RAID) functionality. The disk controller may also perform configuration of the disks. Disk array 328 may also include repeaters for links to the individual storage disks 336.

Each disk 336 may include a storage medium and hardware and software for storing data to and retrieving data from the storage medium. As one example, each disk 336 may include a micro-controller that directs the operations within the disk.

When hardware discovery is performed by management system 220 on storage device 300, the discovery is enhanced to also perform a software inventory of what is currently installed on the storage device. In one embodiment, upon detection of a storage device 300, the management system 220 can load a “live” OS (such as a Preboot Execution Environment (PXE) booted system or vMedia booted system) on one or more storage controllers 304 of storage device 300. In one example, management system 220 of a fabric interconnect device 104 may stream an ISO of the live OS over a connection (e.g., a TCP connection) from the fabric interconnect device 104 to the blade management controller 324 of the storage device 300 and then the ISO will be listed as one of the bootable devices on the storage device 300. Accordingly, storage controller 304 may then boot into the ISO.

The ISO of the OS may include various scripts to determine the hardware components installed in storage device. The OS may also run scripts that determine, for each hardware component, whether associated software has been installed for the hardware component and if so, what the version of the software is. For example, the OS may determine for a particular hardware component whether (and what version of) associated firmware is installed in storage device 300. The OS may determine any of the software installed in storage device 300 such as: disk controller (e.g., SCSI controller) firmware, network adapter firmware, SAS expander firmware, SAS-SATA bridge firmware, BIOS, blade management controller 324 firmware, hard disk 336 firmware, disk 336 micro-controller firmware, power sequencer firmware, retimer firmware, repeater firmware, NVDIMM FPGA firmware, and any other firmware for hardware components within storage device 300. The discovery scripts are run and an inventory of the hardware components and their associated software is passed to the blade management controller 324 to be sent to the management system 220 of the fabric interconnect device 104. This information is stored in a database on the fabric interconnect device 104, which tracks the current versions of software installed for the various hardware components.

The live OS may also analyze the boot devices on storage device 300 and check to see if there is a master boot record (MBR). The OS may then check a disk partition inventory (e.g., of memory 312 or one or more of disks 336) to determine if a boot partition exists. If a boot partition exists, it is mounted and the live OS reads a status file (the installer of the software may have written the status file in a post-install script) to determine a version of the software installed for the storage stack. The storage stack software may include an OS that may be executed on storage controller 304 for managing disk array 328. For example, the storage stack software may receive requests regarding disk array 328 and may convert these commands into a format used by disk array 328 and send these commands to the disk array 328. The storage stack software may receive results from the disk array 328 and direct them to an appropriate device through communication interface 316. The storage stack software may also implement RAID functionality and perform other functions with respect to disk array 328. As with the other software components listed above, the version of the storage stack software is sent to the fabric interconnect device 104 through the blade management controller 324 for storage. If no storage stack software has been installed, then the management system 220 is notified accordingly.

Upon receiving an inventory of the software installed (or not installed) at storage device 300, the management system 220 of fabric interconnect 104 may determine whether software versions are available to upgrade the software components in the inventory (and whether software is available to install for any hardware components that do not have any associated software installed). In various embodiments, fabric interconnect 104 may store an indication of preferred software components (e.g., the latest and/or most robust versions) or may easily access such an indication (e.g., from server 148). The software components from the inventory are compared against the preferred software components to determine which software components may be upgraded (or installed for the first time). These software components may then be retrieved from a fabric interconnect device 104, server 148, or other source and transferred to the storage device 130 for installation. In one embodiment, the software upgrade is performed automatically without any user input. In another embodiment, a user may be prompted to specify (or may have specified prior to the inventory being performed) which versions of software components should be installed and/or when such software components should be installed.

In one embodiment, firmware for the various components of storage device 300 is upgraded followed by an upgrading of the storage stack software. In one embodiment, an ISO version of the storage stack software to be installed is streamed through the “live” OS being executed by storage controller 304. Once the upgrade is complete, storage device 300 may begin serving storage requests sent to it by the other devices of system 100.

The management system 220 may periodically (or in response to a notification of newly available software components) compare available software components against the software components installed in the storage device 300. If it is determined that a software component may be updated, the update may be performed immediately, performed later based on a maintenance policy set up by a user, or a user may be prompted for permission to perform the upgrade. In some embodiments, before the upgrade is performed, management system 220 may determine whether the upgrade would result in a disruption of service by the storage device 300 to other devices in system 100. If it would not, then the upgrade may be immediately performed. If the upgrade would result in disruption, then a user may be prompted as to whether to proceed with the upgrade or the upgrade could be delayed (e.g., until a time in which the storage device 300 receives relatively few requests from the other devices of the storage system).

As described above, a maintenance policy may be established by a user to dictate when upgrades are performed. Each device 300 may be associated with its own policy (or a policy may be applied to multiple devices 300). A policy may specify one or more types of upgrades and rules specifying when upgrades for each type should be performed. For example, one or more rules may apply to all upgrades, to upgrades for software related to certain components within storage device 300, to a particular version of a software component, or other type of upgrade. The rules may specify that the upgrade should be performed immediately, at a specified time, only in response to user acknowledgement, or not at all. In some embodiments, there may be separate rules based on whether the upgrade will result in a disruption of service.

In some embodiments, software upgrades may be tailored so as to avoid or minimize disruption of service of storage device 300. Further aspects of the upgrade process will be discussed below in connection with FIGS. 5-8.

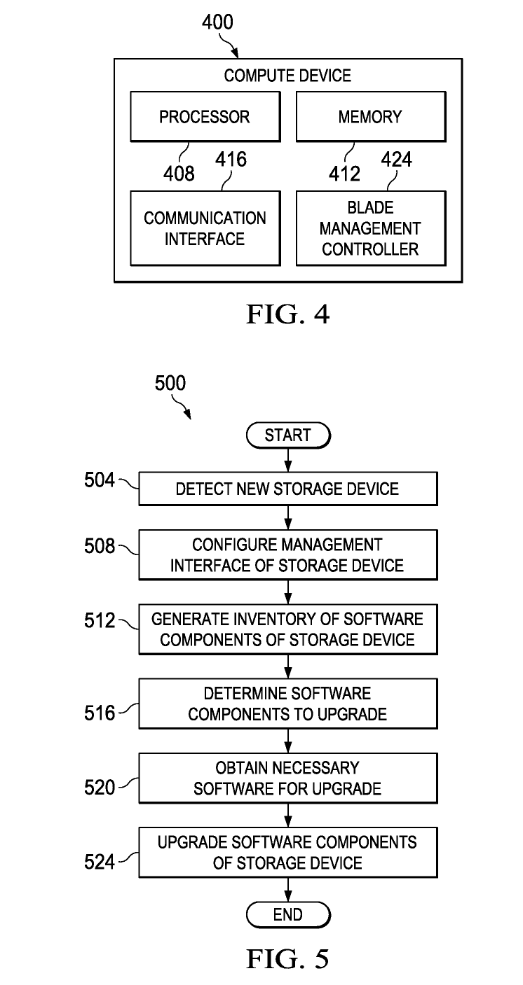

FIG. 4 illustrates an example block diagram of a compute device 400 in accordance with certain embodiments. In addition to the computer system elements described above, compute device 400 may also include blade management controller 424 which is configured to communicate control information with management system 220 of the fabric interconnect device 104. For example, the blade management controller 424 of the compute device 400 may be operable to receive requests (e.g., configuration requests related to components within compute device 300) via communication interface 416, initiate the performance of operations specified by the requests, and to generate control packets or other information to send to other devices of system 100. Examples of operations that may be performed and/or initiated by blade management controller 424 include powering on or powering off any of the components of compute device 400, accessing hardware or software inventory of the components of compute device 400, accessing sensor data associated with any component of storage device 400 (e.g., voltages, currents, temperature, etc.), and monitoring compute device 400. In various embodiments, compute device 400 may be upgraded using methods similar to those described above with respect to storage device 300.

FIG. 5 illustrates an example method 500 for detecting and upgrading a storage device 300 in accordance with certain embodiments. At step 504, a new storage device 300 is detected at a management system running on a fabric interconnect device 104. At step 508, a management interface of the storage device 300 is configured. For example, a blade management controller 324 may be assigned an address and configured to communicate with a management system 220 on a fabric interconnect device 104 using a control protocol. At step 512, an inventory of the software components of the storage device 300 is generated. In addition to the software components that have been installed on storage device 300, the inventory may also include indications of software components that have not been installed on the device (e.g., an indication that no firmware has been installed for a network adapter, disk controller, or other component of the device).

At step 516, a determination of software components to upgrade is performed. This step may involve comparing the inventory of software components with a list of available software components and determining whether software components identified in the inventory should be upgraded to different versions of the software components indicated in the list (or whether software components identified in the list should be installed when there is no corresponding software component installed at storage device 300).

At step 520, software to be installed at the storage device 300 is obtained. In some embodiments, the software may be stored at fabric interconnect device 104 or server 148 and retrieved by the fabric interconnect device 104 and then transmitted to storage device 300. In other embodiments, the fabric interconnect device 104 may instruct server 148 (or other device storing the software) to transmit the software to the storage device 300 or may instruct the storage device 300 to request the software from a particular device. At step 524, the software components obtained at step 520 are installed by storage device 300.

Some of the steps illustrated in FIG. 5 may be repeated, combined, modified or deleted where appropriate, and additional steps may also be added to the flowchart. Additionally, steps may be performed in any suitable order without departing from the scope of particular embodiments. Any suitable logic (e.g., management system 220, blade management controller 324, controller logic 320, or other logic of system 100) may perform some or all of the steps of method 500.

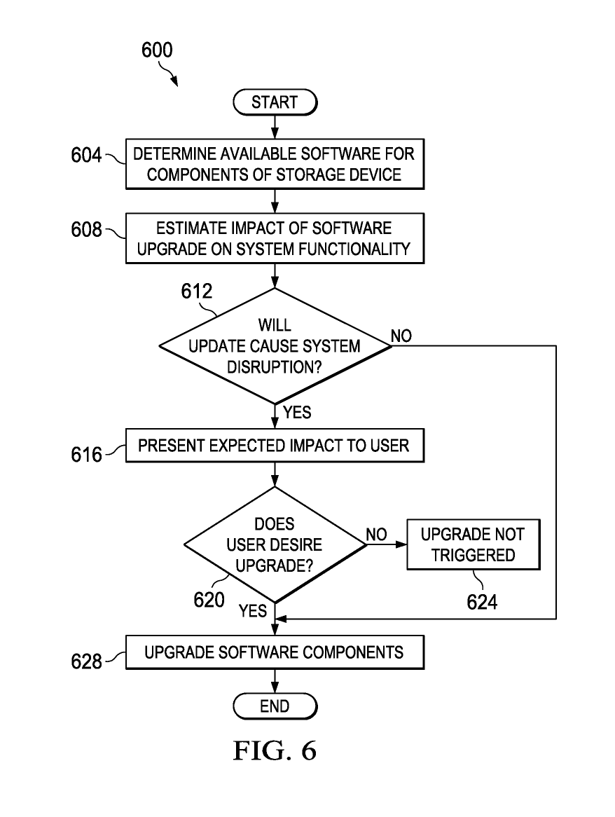

FIG. 6 illustrates an example method 600 for upgrading a storage device based on user input in connection with system impact information in accordance with certain embodiments. In various embodiments, method 600 may be performed when additional software that may be used to upgrade the storage device is identified by the fabric interconnect device (e.g., a user may have uploaded the software to the fabric interconnect device or the fabric interconnect device may discover the software through communication with a server that stores the software). At step 604, it is determined that software is available to upgrade one or more components of a storage device, such as device 300. At step 608, an impact of the software upgrade on the system functionality of the device is estimated. For example, an analysis may be made as to whether the impact will result in disruption of service provided by the storage device to other devices that utilize the storage array of the storage device. As an example, if a storage device has only one functioning storage controller and the upgrade would result in taking that storage controller offline, then it may be determined that a disruption of service will occur if the upgrade is performed. As another example, the paths from each compute device utilizing the storage device may be analyzed (e.g., by management system 220) to determine whether the storage device will be unreachable from one or more of the compute devices if the upgrade proceeds. Some compute devices may only be coupled to the storage device through one of the storage controllers of the storage device and thus if that storage controller needs to be taken offline during the upgrade those compute devices will lose access to the storage device during the upgrade.

At step 612, if it is determined that the impact will not result in disruption of service provided by the storage device, then the method moves to step 628 where the software components are upgraded. If instead it is determined that disruption will result then the expected impact may be presented to a user at step 616. For example, the user may be provided with a list of compute devices that the disruption will affect, how long the storage device will be unavailable to each compute device, or other information associated with the upgrade. The user may be prompted as to whether to proceed with the upgrade. If the user decides to proceed in spite of the disruption, the software components are upgraded at step 628. Alternatively, the user may determine not to perform the upgrade at that time and the upgrade is not triggered at step 624. In some embodiments, the upgrade may be delayed for a chosen amount of time (e.g., until it will not cause a disruption or until a specified time) or may be performed when method 600 is initiated at a later time.

Some of the steps illustrated in FIG. 6 may be repeated, combined, modified or deleted where appropriate, and additional steps may also be added to the flowchart. Additionally, steps may be performed in any suitable order without departing from the scope of particular embodiments. Any suitable logic (e.g., management system 220, blade management controller 324, controller logic 320, or other logic of system 100) may perform some or all of the steps of method 600.

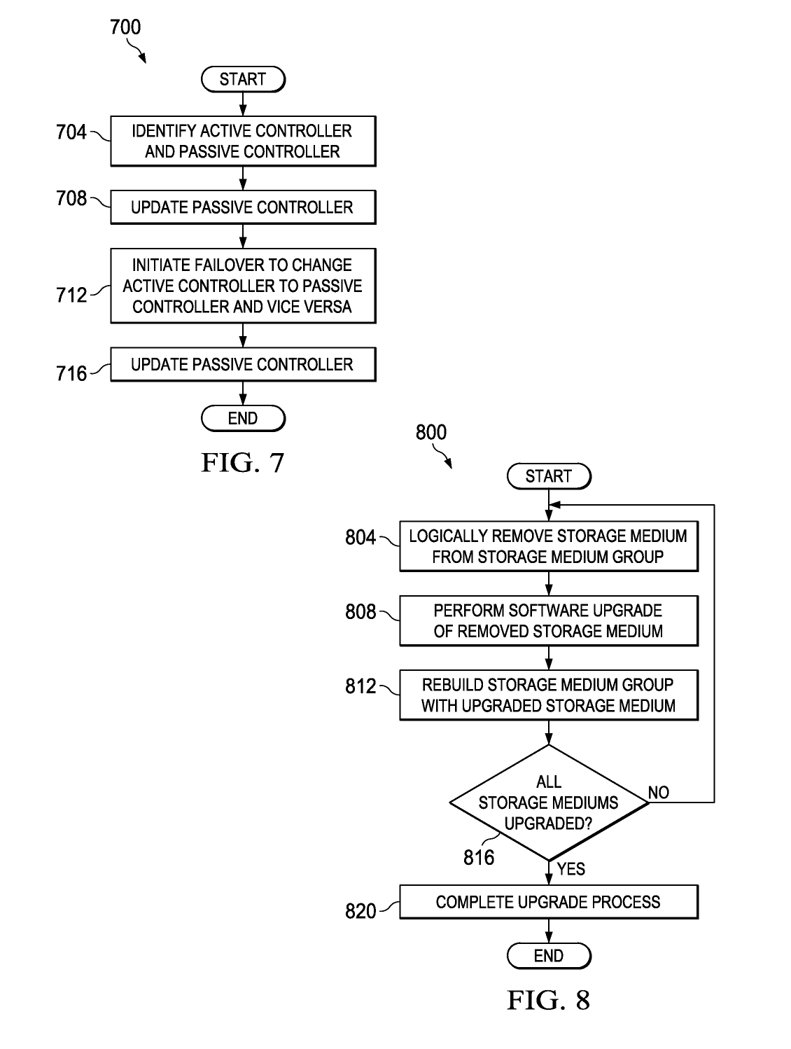

FIG. 7 illustrates an example method 700 for maintaining availability of a storage device during upgrading of the storage device in accordance with certain embodiments. At step 704, an active storage controller and a passive storage controller of a storage device, such as device 300 are identified. At step 708, the passive storage controller is updated. For example, one or more updated software components may be installed on the passive storage controller. While these software components are installed, the active controller continues to serve storage requests received from various devices in system 100, thus maintaining availability of the disk array 328 to the other devices.

At step 712, a failover process is initiated to change the active storage controller to the passive storage controller and the passive storage controller to the active storage controller. As an example, the active storage controller may send a message to the passive storage controller instructing it to assume a role as the active storage controller. In other embodiments, the passive storage controller may otherwise sense or be informed that the active storage controller has gone offline and may assume the role as the active storage controller. Accordingly, the updated storage controller may now serve storage requests from the other devices of the system as the active storage controller while the other controller (now acting as the passive controller) is updated with new software components at step 716.

Some of the steps illustrated in FIG. 7 may be repeated, combined, modified or deleted where appropriate, and additional steps may also be added to the flowchart. Additionally, steps may be performed in any suitable order without departing from the scope of particular embodiments. Any suitable logic (e.g., management system 220, blade management controller 324, controller logic 320, or other logic of system 100) may perform some or all of the steps of method 700.

FIG. 8 illustrates an example method for maintaining availability of a storage medium group during storage medium upgrading in accordance with certain embodiments. At step 804, a storage medium is logically removed from a storage medium group. In one example, a storage medium group may comprise a disk array such as disk array 328, and a storage medium may comprise a disk 336a of the disk array. In some instances, the storage mediums of the storage medium group may function together as a single logical group. For example, in a RAID array, data (e.g., one or more files) may be spread across a plurality of storage mediums. As part of the removal process of a storage medium from the logical group, some or all of the data that is stored by the storage medium is rewritten to the other storage mediums of the group. For example, in the embodiment of FIG. 3, if data was striped over disks 336a-d, the data stored by disk 336a would be rewritten across disks 336b-d such that the data would be striped over disks 336b-d.

Once the storage medium has been logically removed from the group, a software upgrade is performed on the storage medium at step 808. As an example, firmware associated with the storage medium (such as disk firmware) may be upgraded. The storage medium may be reset and the group is then rebuilt with the upgraded storage medium included at step 812. For example, disk 336a could receive data from some or all of disks 336b-d at this step and/or parity syncing may be performed. At step 816, it is determined whether all of the storage mediums of the storage medium group have been updated. If not, steps 804, 808, and 812 may be repeated for each storage medium that is to be upgraded. The upgrade process is then completed at step 820.

Some of the steps illustrated in FIG. 8 may be repeated, combined, modified or deleted where appropriate, and additional steps may also be added to the flowchart. Additionally, steps may be performed in any suitable order without departing from the scope of particular embodiments. Any suitable logic (e.g., management system 220, blade management controller 324, controller logic 320, disk logic 332, or other logic of system 100) may perform some or all of the steps of method 800.

It is also important to note that the steps in FIGS. 5-8 illustrate only some of the possible scenarios that may be executed by, or within, the devices and components described herein. Some of these steps may be deleted or removed where appropriate, or these steps may be modified or changed considerably without departing from the scope of the present disclosure. In addition, a number of these operations may have been described as being executed concurrently with, or in parallel to, one or more additional operations. However, the timing of these operations may be altered considerably. The preceding operational flows have been offered for purposes of example and discussion. Substantial flexibility is provided by the devices and components in that any suitable arrangements, chronologies, configurations, and timing mechanisms may be provided without departing from the teachings of the present disclosure.

Additionally, it should be noted that with the examples provided above, interaction may be described in terms of one or more devices or components. However, this has been done for purposes of clarity and example only. In certain cases, it may be easier to describe one or more of the functionalities of a given set of flows by only referencing a limited number of devices or components. It should be appreciated that the systems described herein are readily scalable and, further, can accommodate a large number of devices or components, as well as more complicated/sophisticated arrangements and configurations. Accordingly, the examples provided should not limit the scope or inhibit the broad techniques of provisioning storage devices, as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
accessing, by a fabric interconnect device, a software inventory of a storage device comprising a plurality of hardware components including at least one storage controller and a plurality of storage mediums, the software inventory comprising a plurality of entries, each entry of at least a subset of the plurality of entries identifying a hardware component of the storage device and an indication of at least one version of software installed for use by the hardware component or an indication that no software is installed for use by the hardware component;
determining, by the fabric interconnect device, for each hardware component identified in the at least a subset of the plurality of entries, whether one or more versions of software are available for use by the hardware component; and
initiating installation, by the fabric interconnect device, of at least one version of software for at least one hardware component of the plurality of the hardware components based on the determination.

2. The method of claim 1, further comprising determining whether the installation of the at least one version of software for the at least one hardware component will result in a loss of service of the storage device to one or more compute devices.

3. The method of claim 2, further comprising prompting a user that a loss of service of the storage device to one or more compute devices will result from the installation of the at least one version of software for the at least one hardware component.

4. The method of claim 1, wherein accessing the software inventory of the storage device is performed in response to receiving an indication that the storage device has been installed.

5. The method of claim 4, further comprising automatically assigning an IP address to the storage device in response to the indication that the storage device has been installed.

6. The method of claim 1, further comprising requesting the one or more versions of software over a network in response to the determining whether one or more versions of software are available.

7. The method of claim 1, wherein the storage device is installed in a rack or chassis of a data center.

8. The method of claim 1, wherein:
a first storage controller of the storage device provides access to the plurality of storage mediums of the storage device while software for a second storage controller of the storage device is installed; and
the second storage controller of the storage device provides access to the plurality of storage mediums of the storage device while software for the first storage controller is installed.

9. The method of claim 1, wherein:
data in a first storage medium is transferred to at least one of the other storage mediums of the storage device;
software for the first storage medium is installed; and
in response to the completion of the software update for the first storage medium, data from at least one of the other storage mediums is transferred to the first storage medium.

10. The method of claim 1, further comprising sending, by the fabric interconnect device, the software inventory of the storage device to a backup fabric interconnect device.

11. An apparatus comprising:
an interface to receive a software inventory of a storage device comprising a plurality of hardware components including at least one storage controller and a plurality of storage mediums, the software inventory comprising a plurality of entries, each entry of at least a subset of the plurality of entries identifying a hardware component of the storage device and an indication of at least one version of software installed for use by the hardware component or an indication that no software is installed for use by the hardware component;
at least one memory element to store the software inventory; and
a processor to:
determine for each hardware component identified in the at least a subset of the plurality of entries, whether one or more versions of software are available for use by the hardware component; and
initiate installation of at least one version of software for at least one hardware component of the plurality of the hardware components based on the determination.

12. The apparatus of claim 11, wherein the processor is further to determine whether the installation of the at least one version of software for the at least one hardware component will result in a loss of service of the storage device to one or more compute devices.

13. The apparatus of claim 12, wherein the processor is further to prompt a user that a loss of service of the storage device to one or more compute devices will result from the installation of the at least one version of software for the at least one hardware component.

14. The apparatus of claim 11, wherein the processor is further to:
direct a first storage controller of the storage device to provide access to the plurality of storage mediums of the storage device while software for a second storage controller of the storage device is installed; and
direct the second storage controller of the storage device to provide access to the plurality of storage mediums of the storage device while software for the first storage controller is installed.

15. The apparatus of claim 11, wherein the processor is further to direct a storage device to
transfer data in a first storage medium to at least one of the other storage mediums of the storage device;
install software for the first storage medium; and
transfer data from at least one of the other storage mediums to the first storage medium in response to the completion of the software update for the first storage medium.

16. A computer-readable non-transitory medium comprising one or more instructions that when executed by a machine configure the machine to:
access a software inventory of a storage device comprising a plurality of hardware components including at least one storage controller and a plurality of storage mediums, the software inventory comprising a plurality of entries, each entry of at least a subset of the plurality of entries identifying a hardware component of the storage device and an indication of at least one version of software installed for use by the hardware component or an indication that no software is installed for use by the hardware component;
determine for each hardware component identified in the at least a subset of the plurality of entries, whether one or more versions of software are available for use by the hardware component; and
initiate installation of at least one version of software for at least one hardware component of the plurality of the hardware components based on the determination.

17. The medium of claim 16, the one or more instructions when executed by a machine to further configure the machine to determine whether the installation of the at least one version of software for the at least one hardware component will result in a loss of service of the storage device to one or more compute devices.

18. The medium of claim 17, the one or more instructions when executed by a machine to further configure the machine to prompt a user that a loss of service of the storage device to one or more compute devices will result from the installation of the at least one version of software for the at least one hardware component.

19. The medium of claim 16, the one or more instructions when executed by a machine to further configure the machine to:
direct a first storage controller of the storage device to provide access to the plurality of storage mediums of the storage device while software for a second storage controller of the storage device is installed; and
direct the second storage controller of the storage device to provide access to the plurality of storage mediums of the storage device while software for the first storage controller is installed.

20. The medium of claim 16, the one or more instructions when executed by a machine to further configure the machine to direct a storage device to:
transfer data in a first storage medium to at least one of the other storage mediums of the storage device;
install software for the first storage medium; and
transfer data from at least one of the other storage mediums to the first storage medium in response to the completion of the software update for the first storage medium.
